(19) United States
(12) Patent Application Publication
(10) Pub. No.: US 2013/0148146 A1
(43) Pub. Date: Jun. 13, 2013

(54) TRANSMITTING MODULE AND MULTI-FUNCTIONAL PRINTER USING THE SAME

(71) Applicant: Chih-Hwa Wang, New Taipei City (TW)

(72) Inventor: Chih-Hwa Wang, New Taipei City (TW)

(73) Assignees: Kinpo Electronics, Inc., New Taipei City (TW); Cal-Comp Electronics & Communications Company Limited, New Taipei City (TW)

(21) Appl. No.: 13/526,481

(22) Filed: Jun. 18, 2012

(30) Foreign Application Priority Data
Dec. 12, 2011 (TW) 100145747

(51) Int. Cl. G06K 15/02; F16H 7/02

(52) U.S. Cl. 358/1.13; 474/148

(57) ABSTRACT

A transmitting module and a multi-functional printer (MFP) using the same are provided. The transmitting module includes at least two rotating shafts and a transmission belt. Each rotating shaft has at least one oblique cone-trough. The transmission belt surrounds the rotating shafts and rotates along with rotation of the rotating shafts. The transmission belt has a main body and at least one cone positioning structure, in which the cone positioning structure is disposed on a bottom surface of the main body and correspondingly tightly fits in the oblique cone-trough. When being applied to the MFP, the transmitting module provides a scanning or printing function according to configuration relations with other modules.

### CROSS-REFERENCE TO RELATED APPLICATION

This application claims the priority benefit of Taiwan application serial no. 100145747, filed on Dec. 12, 2011. The entirety of the above-mentioned patent application is hereby incorporated by reference herein and made a part of this specification.

### BACKGROUND OF THE INVENTION

1. Field of the Invention

The present invention generally relates to a module and a device, and in particular, to a transmitting module and a multi-functional printer (MFP) using the same.

2. Description of Related Art

With informatization of society, offices are disposed with scanners, photocopiers, printers, or other office automatic devices, and users may perform word processing operations by using the office automatic devices. It should be noted that when being configured in the office at the same time, the various office automatic devices occupy a lot of space. Therefore, a multi-functional printer (MFP) integrating photocopying, printing, scanning, and other functions are developed, so as to solve the problem.

In detail, both a scanning module and a printing module in the MFP need to use a transmission belt and a rotating shaft. Along with rotation of the rotating shaft, the transmission belt drives the scanning module to move to perform scanning, or carries carbon powder and cooperates with a photo-sensitive drum and a transfer roller to perform printing.

However, the transmission belt is only sleeved on the rotating shaft, so that the transmission belt easily snakes left and right along a shaft direction of the rotating shaft and relative to the rotating shaft. In this manner, a scanning result or printing quality may be affected.

### SUMMARY OF THE INVENTION

Accordingly, the present invention is directed to a transmitting module, in which a transmission belt has an excellent fixedness relative to a rotating shaft.

The present invention is further directed to an MFP using the transmitting module.

The present invention provides a transmitting module, which includes at least two rotating shafts and a transmission belt. Each rotating shaft has at least one oblique cone-trough. The transmission belt surrounds the rotating shafts, and rotates along with rotation of the rotating shafts. The transmission belt has a main body and at least one cone positioning structure, the cone positioning structure is disposed on a bottom surface of the main body, and correspondingly tightly fits in the oblique cone-trough.

In an embodiment of the transmitting module according to the present invention, one rotating shaft is a driving shaft, and the other rotating shaft is a driven shaft.

In an embodiment of the transmitting module according to the present invention, when the cone positioning structure is correspondingly accommodated in the oblique cone-trough, two chamfers of the cone positioning structure are tightly sealed with two oblique sidewalls of the oblique cone-trough.

In an embodiment of the transmitting module according to the present invention, the cone positioning structure is elastic.

In an embodiment of the transmitting module according to the present invention, the cone positioning structure and the main body are integrally formed.

In an embodiment of the transmitting module according to the present invention, a material of the transmission belt is rubber.

In an embodiment of the transmitting module according to the present invention, a shape of the cone positioning structure is right-left symmetrical.

The present invention also provides an MFP, which includes a body, a scanning module, a driving module, and a transmitting module of any one of the embodiments mentioned above. The scanning module, the driving module, and the transmitting module are disposed in the body, in which the transmitting module is connected between the driving module and the scanning module.

In an embodiment of the MFP according to the present invention, the MFP further includes a scanning platform disposed in the body, in which the scanning module is located on the scanning platform, the transmitting module is located besides the scanning platform, and the scanning module is suitable for moving relative to the scanning platform.

The present invention further provides an MFP, which includes a body, a transmitting module of any one of the embodiments mentioned above, a photo-sensitive drum, and a transfer roller. The transmitting module, the photo-sensitive drum, and the transfer roller are disposed in the body, in which the photo-sensitive drum and the transfer roller contact the transmission belt, and the photo-sensitive drum does not physically contact the transfer roller.

In an embodiment of the MFP according to the present invention, the MFP further includes a pickup roller and a paper heating element, in which the transfer roller is located between the pickup roller and the paper heating element.

Based on the above mentioned, in a transmitting module of the present invention, through cooperation of a core positioning structure of a transmission belt and an oblique cone-trough of a rotating shaft, the transmission belt and the rotating shaft have an excellent positioning effect, so that during operation of the transmitting module, the transmission belt does not snake left and right relative to the rotating shaft. An MFP using the transmitting module may have an excellent scanning or printing effect.

In order to make the aforementioned features and advantages of the present invention more comprehensible, embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1A is a schematic three-dimensional view of a transmitting module according to a first embodiment of the present invention.

FIG. 1B is a side view of the transmitting module of FIG. 1A.

FIG. 2 is a schematic cross-sectional view along a section line A-A and passing through a shaft center B of a rotating shaft of FIG. 1A.

FIG. 3 is a schematic view of a second embodiment of the present invention.

FIG. 4 is a schematic view of a third embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

### First Embodiment

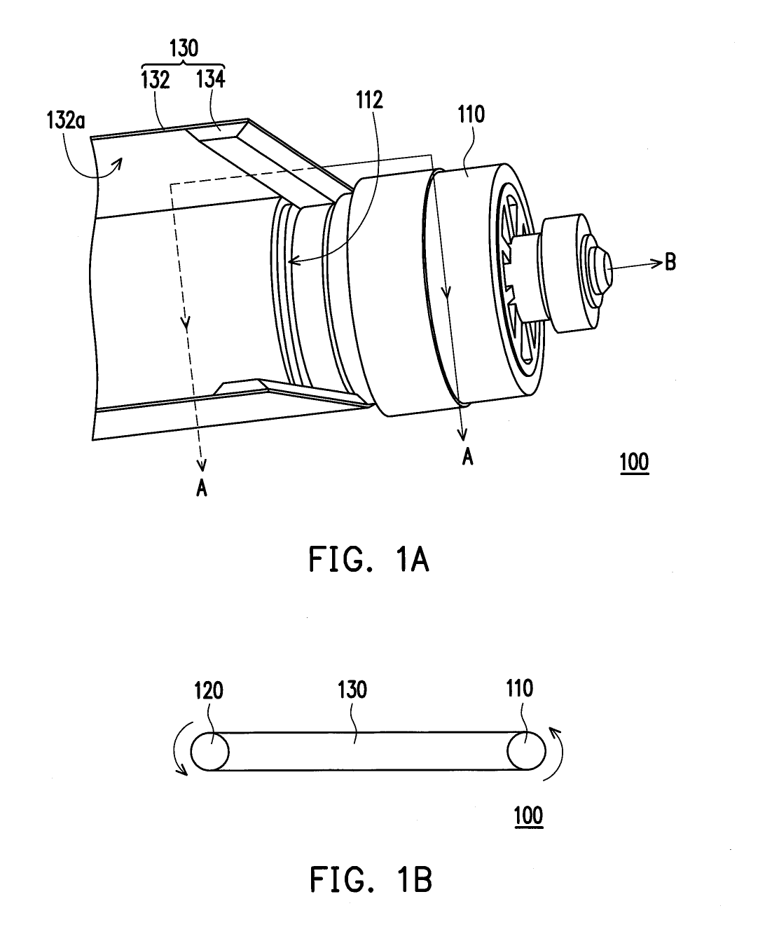

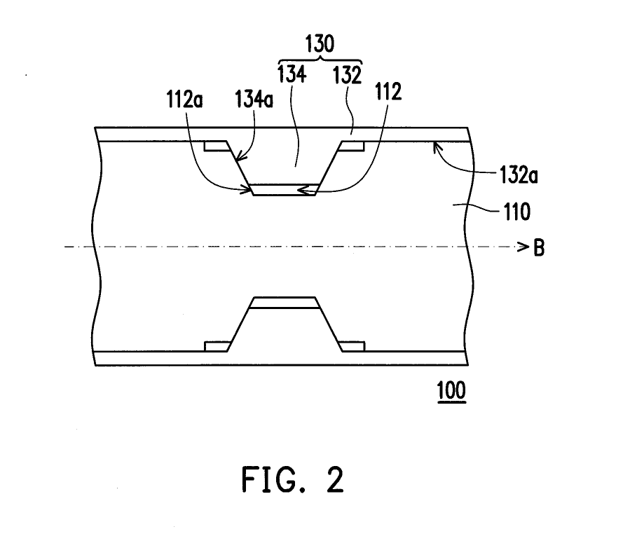

FIG. 1A is a schematic three-dimensional view of a transmitting module according to a first embodiment of the present invention. FIG. 1B is a side view of the transmitting module of FIG. 1A. FIG. 2 is a schematic cross-sectional view along a section line A-A and passing through a shaft center B of a rotating shaft of FIG. 1A. Referring to FIG. 1A, FIG. 1B, and FIG. 2, the transmitting module 100 includes at least two rotating shafts 110, 120 and a transmission belt 130. Any one of the rotating shafts 110, 120 has at least one oblique cone-trough (FIG. 1A only shows the oblique cone-trough 112 of the rotating shaft 110), the transmission belt 130 surrounds the rotating shafts 110, 120, and the transmission belt 130 rotates along with rotation of the rotating shafts 110, 120. The transmission belt 130 has a main body 132 and at least one cone positioning structure 134, the cone positioning structure 134 is disposed on a bottom surface 132a of the main body 132, and correspondingly tightly fits in the oblique cone-trough 112.

In detail, a material of the transmission belt 130 is rubber, and the cone positioning structure 134 and the main body 132 are integrally formed. In other words, the cone positioning structure 134 is elastic. In addition, a shape of the cone positioning structure 134 is right-left symmetrical, and is the same as a shape of the oblique cone-trough 112, so that the cone positioning structure 134 may be correspondingly accommodated in the oblique cone-trough 112 with the satisfied shape, and two chamfers 134a of the cone positioning structure 134 are tightly sealed with two oblique sidewalls 112a of the oblique cone-trough 112. Further, a depth of the oblique cone-trough 112 is greater than a height of the cone positioning structure 134. Further, one rotating shaft 110 (or 120) is a driving shaft, and the other rotating shaft 120 (or 110) is a driven shaft. In other embodiments, the cone positioning structure 134 may also be bonded to the main body 132.

Accordingly, during operation of the transmitting module 100, for example, the rotating shaft 110 is connected to a motive power source for illustration, in which the motive power source may be a motor, and operation of the motor drives the rotating shaft 110 serving as the driving shaft to drive the transmission belt 130 to start to rotate, so as to drive the rotating shaft 120 serving as the driven shaft to rotate. Particularly, a size of the cone positioning structure 134 is made to be slightly greater than a size of the oblique cone-trough 112, in this manner, when the cone positioning structure 134 is correspondingly accommodated in the oblique cone-trough 112, as the cone positioning structure 134 is elastic, the two chamfers 134a of the cone positioning structure 134 are squeezed by the two oblique sidewalls 112a of the oblique cone-trough 112 and extend and are deformed towards a bottom part of the oblique cone-trough 112, and as the depth of the oblique cone-trough 112 is greater than the height of the cone positioning structure 134, the oblique cone-trough 112 has a gap capable of accommodating an extending and deformed part of the cone positioning structure 134. Further, as the shape of the cone positioning structure 134 is right-left symmetrical, the cone positioning structure 134 may achieve mechanical equilibrium with the oblique cone-trough 112 having the satisfied shape, and the cone positioning structure 134 is not inclined to left or right along the shaft direction B relative to the oblique cone-trough 112.

Based on the above mentioned, as the cone positioning structure 134 tightly fits in the oblique cone-trough 112, and the shape of the cone positioning structure 134 is right-left symmetrical, during the operation of the transmitting module 100, mutual interference friction between the transmission belt 130 and the rotating shaft 110 (or 120) enables the transmission belt 130 and the rotating shaft 110 (or 120) to have an interference friction force greater than that between the transmission belt and the rotating shaft in the conventional art, the transmission belt 130 does not snake left and right along the shaft direction B of the rotating shaft 110 (or 120), and compared with the conventional art, the transmission belt 130 and the rotating shaft 110 (or 120) according to this embodiment have a better positioning effect.

### Second Embodiment

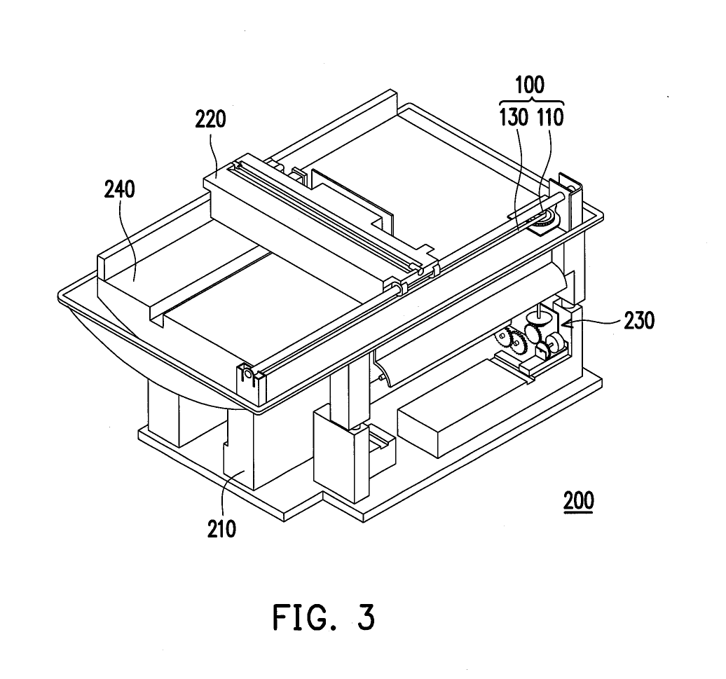

FIG. 3 is a schematic view of a second embodiment of the present invention. In this embodiment, the transmitting module of FIG. 1A is applied to an MFP, and cooperates with a scanning module of the MFP, so as to provide a scanning function. Referring to FIG. 3, the MFP 200 of this embodiment has a body 210, a scanning module 220, a driving module 230, the transmitting module 100 of the first embodiment, and a scanning platform 240. The scanning module 220, the driving module 230, the scanning platform 240, and the transmitting module 100 are disposed in the body 210, in which the scanning module 220 is disposed on the scanning platform 240, the transmitting module 100 is located besides the scanning platform 240, and is connected between the driving module 230 and the scanning module 220, and the transmitting module 100 is suitable for driving the scanning module 220 to move relative to the scanning platform 240.

In detail, the driving module 230 is a combination of a motor and gears, in which one rotating shaft 110 of the transmitting module 100 is connected to the driving module 230, and the other rotating shaft is not shown in FIG. 3. The scanning module 220 is connected to the transmission belt 130, and the scanning module 220 is driven by rotation of the transmission belt 130.

During a scanning procedure, the driving module 230 starts to operate, so as to drive the rotating shaft 110 of the transmitting module 100 to drive the transmission belt 130 to rotate, and the scanning module 220 is driven by the transmission belt 130 to move relative to the scanning platform 240, so as to perform the scanning procedure.

The transmission belt 130 and the rotating shaft 110 of the transmitting module 100 have an excellent positioning effect, so that the transmission belt 130 does not snake left and right along the rotating shaft 110, so the scanning procedure performed by using the MFP 200 may obtain a good scanning effect.

### Third Embodiment

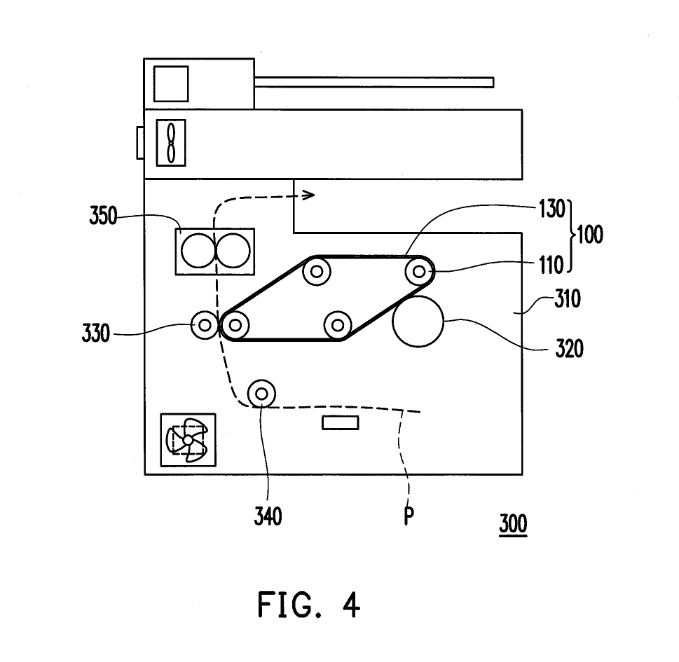

FIG. 4 is a schematic view of a third embodiment of the present invention. In this embodiment, the transmitting module of FIG. 1A is applied to an MFP, and cooperates with a transfer roller and a photo-sensitive drum to provide a printing function.

Referring to FIG. 4, the MFP 300 of this embodiment has a body 310, the transmitting module 100, a photo-sensitive drum 320, and a transfer roller 330. In this embodiment, the transmitting module 100 has 4 rotating shafts 110, and in order to clarify the drawing, the rotating shafts are marked by a numeral 110. A transmission belt 130 of the transmitting module 100 respectively contacts the photo-sensitive drum 320 and the transfer roller 330, but the photo-sensitive drum 320 does not physically contact the transfer roller 330.

In addition, the MFP 300 further has a pickup roller 340 and a paper heating element 350, in which the pickup roller 340, the paper heating element 350, the transfer roller 330, and the transmitting module 100 define a paper conveying path P together. In detail, the pickup roller 340 enables paper to enter the paper conveying path P, and pass through the transfer roller 330 and the paper heating element 350 in sequence for being printed. Further, the pickup roller 340 drives the paper (not shown) to move to the transfer roller 330 along the paper conveying path P. After carbon powder is arranged on the paper through cooperation of the photo-sensitive drum 320, the transmission belt 130 of the transmitting module 100, and the transfer roller 116, the paper is conveyed to the paper heating element 350 for being heated, so that the carbon powder is fixed on the paper.

The transmission belt 130 and the rotating shaft 110 of the transmitting module 100 have an excellent positioning effect, so that the transmission belt 130 does not snake left and right along the rotating shaft 110, so a printing procedure performed by using the MFP 300 may obtain an excellent printing quality.

The second and the third embodiments are only used to exemplify the possible application scope of the transmitting module, but the present invention is not limited thereto. The transmitting module of the present invention may be applied to any situation requiring preventing the transmission belt from snaking left and right relative to the rotating shaft, for example, transportation of precise objects, so as to prevent inner parts of the precise objects from being collided and damaged after being shaken left and right.

To sum, in a transmitting module of the present invention, through cooperation of a cone positioning structure of a transmission belt and an oblique cone-trough of a rotating shaft, the transmission belt and the rotating shaft have an excellent positioning effect, so that during operation of the transmitting module, the transmission belt does not snake left-right relative to the rotating shaft. The transmitting module is applied to an MFP, and when a scanning module is used, the MFP has an excellent scanning effect; and when a printing module (for example, a transfer roller, a photo-sensitive drum, and a heating element) is used, an excellent printing quality is obtained. In addition, the transmitting module may be further applied to transportation of other precise products, so as to prevent the transmission belt from shaking left and right as in the conventional art to result in that inner parts of the precise objects are collided and damaged, thereby improving yield of the precise objects before delivery.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A transmitting module, comprising:
at least two rotating shafts, each comprising at least one oblique cone-trough; and
a transmission belt, surrounding the rotating shafts, and rotating along with rotation of the rotating shafts, wherein the transmission belt comprises a main body and at least one cone positioning structure, the at least one cone positioning structure is disposed on a bottom surface of the main body, and correspondingly tightly fits in the at least one oblique cone-trough.

2. The transmitting module according to claim 1, wherein one of the rotating shafts is a driving shaft, and the other one of the rotating shafts is a driven shaft.

3. The transmitting module according to claim 1, wherein when the at least one cone positioning structure is correspondingly accommodated in the at least one oblique cone-trough, two chamfers of the at least one cone positioning structure are tightly sealed with two oblique sidewalls of the at least one oblique cone-trough.

4. The transmitting module according to claim 1, wherein the at least one cone positioning structure is elastic.

5. The transmitting module according to claim 1, wherein the at least one cone positioning structure and the main body are integrally formed.

6. The transmitting module according to claim 1, wherein a material of the transmission belt is rubber.

7. The transmitting module according to claim 1, wherein a shape of the at least one cone positioning structure is right-left symmetrical.

8. A multi-functional printer (MFP), comprising:
a body;
a scanning module, disposed in the body;
a driving module, disposed in the body;
a transmitting module, connected between the driving module and the scanning module, and comprising:
at least two rotating shafts, each comprising at least one oblique cone-trough; and
a transmission belt, surrounding the rotating shafts, and rotating along with rotation of the rotating shafts, wherein the scanning module is driven by the transmission belt, the transmission belt comprises a main body and at least one cone positioning structure, the at least one cone positioning structure is disposed on a bottom surface of the main body, and correspondingly tightly fits in the at least one oblique cone-trough.

9. The MFP according to claim 8, wherein one of the rotating shafts is a driving shaft and the other one of the rotating shafts is a driven shaft.

10. The MFP according to claim 8, wherein when the at least one cone positioning structure is correspondingly accommodated in the at least one oblique cone-trough, two chamfers of the at least one cone positioning structure are tightly sealed with two oblique sidewalls of the at least one oblique cone-trough.

11. The MFP according to claim 8, wherein the at least one cone positioning structure is elastic.

12. The MFP according to claim 8, wherein the at least one cone positioning structure and the main body are integrally formed.

13. The MFP according to claim 8, wherein a material of the transmission belt is rubber.

14. The MFP according to claim 8, wherein a shape of the at least one cone positioning structure is right-left symmetrical.

15. The MFP according to claim 8, further comprising a scanning platform, disposed in the body, wherein the scanning module is located on the scanning platform, the transmitting module is located besides the scanning platform, and the scanning module is suitable for moving relative to the scanning platform.

16. A multi-functional printer (MFP), comprising:
a body;
a transmitting module, disposed in the body, and comprising:
at least two rotating shafts, each comprising at least one oblique cone-trough; and
a transmission belt, surrounding the rotating shafts, and rotating along with rotation of the rotating shafts, wherein the transmission belt comprises a main body and at least one cone positioning structure, the at least one cone positioning structure is disposed on a bottom surface of the main body, and correspondingly tightly fits in the at least one oblique cone-trough;
a photo-sensitive drum, disposed in the body, and contacting the transmission belt; and
a transfer roller, disposed in the body, and contacting the transmission belt.

17. The MFP according to claim 16, wherein when the at least one cone positioning structure is correspondingly accommodated in the at least one oblique cone-trough, two chamfers of the at least one cone positioning structure are tightly sealed with two oblique sidewalls of the at least one oblique cone-trough.

18. The MFP according to claim 16, wherein the at least one cone positioning structure is elastic.

19. The MFP according to claim 16, wherein the at least one cone positioning structure and the main body are integrally formed.

20. The MFP according to claim 16, wherein a material of the transmission belt is rubber.

21. The MFP according to claim 16, wherein a shape of the at least one cone positioning structure is right-left symmetrical.

22. The MFP according to claim 16, further comprising a pickup roller and a paper heating element, wherein the transfer roller is located between the pickup roller and the paper heating element.
